(19) United States
(12) Patent Application Publication
(10) Pub. No.: US 2013/0068393 A1
(43) Pub. Date: Mar. 21, 2013

(54) LAMINATING EQUIPMENT FOR TOUCH PANEL

(71) Applicant: Kai-Ti YANG, Taoyuan (TW)

(72) Inventor: Kai-Ti YANG, Taoyuan (TW)

(21) Appl. No.: 13/235,486

(22) Filed: Sep. 18, 2011

(51) Int. Cl. B29C 65/02

(52) U.S. Cl. 156/382

(57) ABSTRACT

An improved laminating equipment for touch panel includes a working recess and a pressing cap. The working recess has a first and a second positioning frame for precisely positioning a first and a second plate respectively. A plurality of elastic supporter is arranged between the first and the second positioning frame for forming a gap between the first and the second plates. The pressing cap has a pressing unit having a soft contact surface on a bottom surface thereof. The working recess is sealed by covering of the pressing cap to create vacuum by a vacuum pump during the laminating process. The pressing unit will provide a downward force to the second plate to overcome the support of the plurality of elastic supporter so as to attach the first and the second plates as one.

### FIELD OF THE INVENTION

The present invention relates to laminating equipment for touch panel, and particular to an improved laminating equipment for pressing a glass plate with a hard plate or flexible film layers as one.

### DESCRIPTION OF THE PRIOR ART

Touch panel is a laminate of multiple glasses or flexible films with two separated resistive films arranged oppositely within the laminate. The processes of laminating are usually done by applying force to either the flexible films fixed on an upper platform or the glass fixed on a lower platform so as to attach the two by a prearranged glue layer and the pressure applied.

Through the above process, the plate and the films must be placed on the platforms through alignment by predetermined marks. Such method is complicated and time-consuming with low efficiency. Quality is not stable due to artificial mistakes. The platforms are activated by cylinder which contributes power in a point so that deformations are easily happened after long-term operation or enormous stress. A flat and smooth pressing won't be able to achieve under such situation. Moreover, the force supplying by the cylinder shaft is not uniformly applied to the platforms and the plates. Especially when the plates are not placed well, uneven forces to the plates could cause tilt attachment or breakage to the panel. During the process in the atmosphere, bubbles are easily remained inside the laminate and end in a failure.

### SUMMARY OF THE PRESENT INVENTION

Accordingly, the primary object of the present invention is to provide an improved laminating equipment having positioning frames for quickly and precisely placement and vacuum chamber for process. The soft contact surface of a pressing unit thereof will provide uniformly force to the plates so as to achieve a smooth and flat attachment.

The various objects and advantages of the present invention will be more readily understood from the following detailed description when read in conjunction with the appended drawing.

### BRIEF DESCRIPTION OF THE DRAWINGS

FIG. 1 is a cross sectional view of the present invention, wherein the pressing cap and the working recess is separated.

FIG. 2 is an elevational view of the working recess of the present invention.

FIG. 3 is a lateral cross sectional view of the present invention, wherein the pressing cap is combined with the working recess.

FIG. 4 is a lateral cross sectional view of the present invention, wherein when the elastic film is inflated and then the upper and lower plates are pressed to be combined.

FIG. 5 is a lateral cross sectional view of the present invention.

FIG. 6 is a lateral cross sectional view of the present invention, where when the elastic film is inflated and then the upper and lower plates are pressed to be combined.

FIG. 7 is a lateral cross sectional view of a further embodiment of the present invention.

FIG. 8 a lateral cross sectional view of a further embodiment of the present invention, where when the elastic film is inflated and then the upper and lower plates are pressed to be combined.

### DETAILED DESCRIPTION OF THE IVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

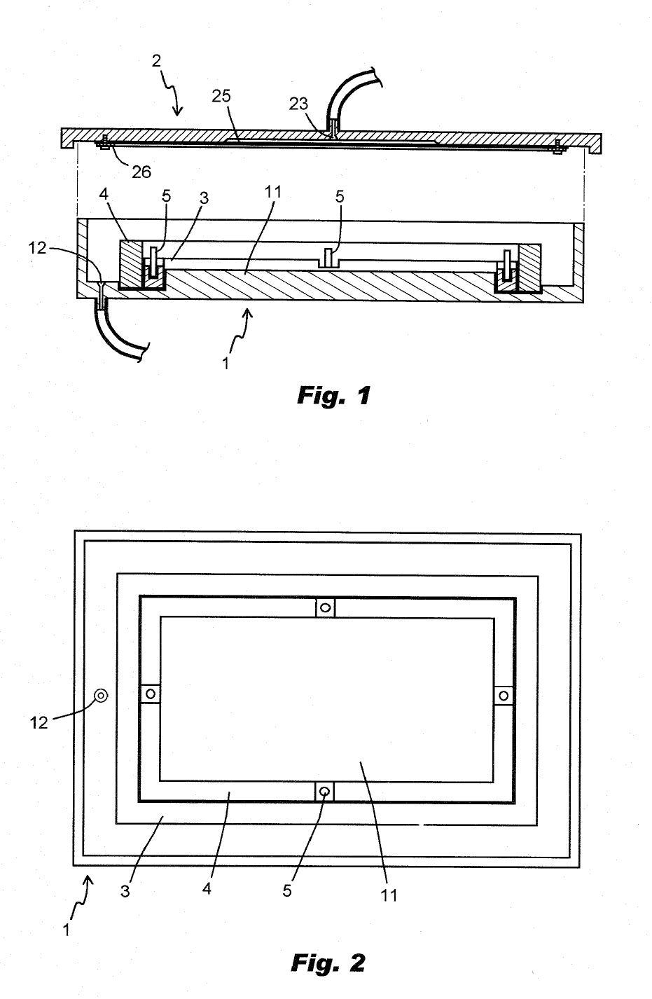

Referring to FIGS. 1 and 2, a preferable embodiment according to the present invention is illustrated. An improved laminating equipment for touch panel of the present invention includes a working recess 1 and a pressing cap 2. The working recess 1 is a rectangular concave having a base plate 11 on a bottom center of the concave. A vent 12 connected to a vacuum pump (not shown in Fig.) is formed to the working recess 1. The base plate 11 has a lower plate positioning frame 3 on a periphery thereof. A lower plate 6 of a working piece can be placed in the lower plate positioning frame 3 so as to position the lower plate 6 quickly and precisely. A top of the frame of the lower plate positioning frame 3 is lower than the top of the lower plate 6 being placed thereon for preventing interference. An upper plate positioning frame 4 is formed outside the periphery of the lower plate positioning frame 3. Inside the frame of the upper plate positioning frame 4, at least four elastic bolts 5 are formed on the top of the wall of the lower plate positioning frame 3. An upper plate 7 of the working piece can be placed in the upper plate positioning frame 4 with the elastic bolts 5 supporting a bottom surface of the upper plate 7 so as to position the upper plate 7 quickly and precisely. By the supporting of the elastic bolts 5, a gap is formed between the lower plate 6 and the upper plate 7. A top of the frame of the upper plate positioning frame 4 is lower than the top of the upper plate 7 being placed thereon for preventing interference. The elastic bolts 5 are made of deformable material such as crude rubber, composite rubber, or elastic plastic. In addition, a gluing layer 8 is arranged between the upper and lower plates. The gluing layer 8 made of optic glue or isoprene is arranged to an upper surface of the lower plate 6 or a lower surface of the upper plate 7 by coating or printing. Moreover, the upper plate 7 is preferably a hard plate such as a thin plate of glass so as to be positioned and supporting by the elastic bolts 5. The lower plate 6 can be a hard plate or soft films.

The pressing cap 2 arranged above the working recess 1 serves to cover upon the working recess 1. An elastic film 25 is arranged to a bottom surface of the pressing cap 2. A periphery of the elastic film 25 is fixed by a suppression ring 26 so as to seal and fix the elastic film 25 to the pressing cap 2. An inflation space is formed to the elastic film 25 within the suppression ring 26, and a vent 23 connected to a pump is formed to the bottom surface of the pressing cap 2. The elastic film 25 is made of rubber. The inflation and the inflation pressure to the elastic film 25 can be controlled by the pump connected to the vent 23.

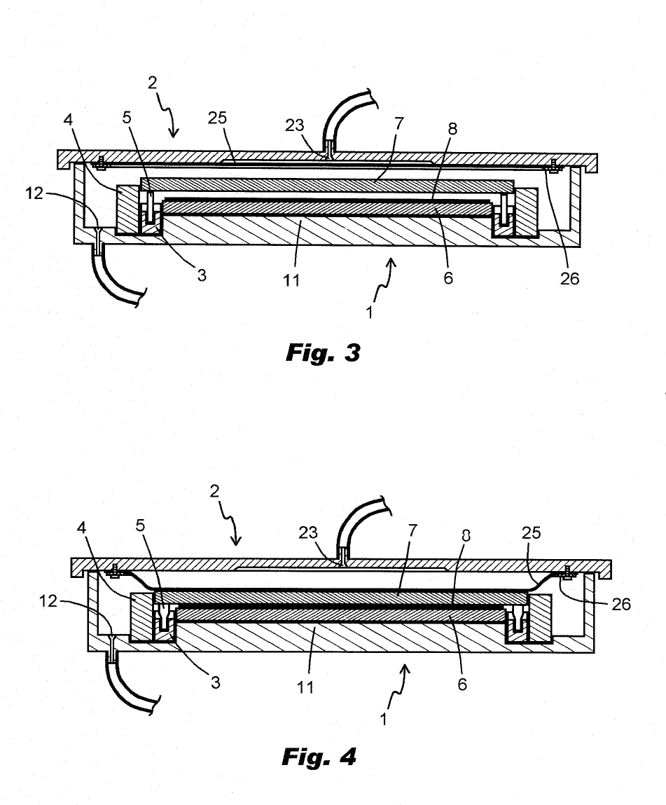

Referring to FIGS. 3 and 4, the lower plate 6 is placed onto the base plate 11 in the lower plate positioning frame 3, and the upper plate 7 is placed onto the elastic bolts 5 in the upper plate positioning frame 4. The working recess 1 is sealed by the covering of the pressing cap 2 so that vacuum is created inside the working recess 1 by the vacuum pump. The elastic film 25 is simultaneously inflated by the pump to create a force pushing downward. The upper plate 7 is pushed by the inflated elastic film 25, and the downward force is uniformly applied to the upper plate 7 so that the elastic bolts 5 will be pushed down and the upper plate 7 is attached to the lower plate 6. After the attachment of the lower plate 6 and the upper plate 7 is completed, the elastic film 25 will be deflated by releasing air and the working recess 1 is vented so that the pressing cap 2 can be raised to obtain the finished panel.

Through the above components, the present invention can position the upper and lower plates 6 and 7 precisely by the positioning frames 3 and 4 in the working recess 1. The elastic film 25 can be inflated to create uniformly force for smoothly pressing the plates together and prevent breakage. By the vacuum enclosed within the pressing cap 2 and the working recess 1, bubbles remained in the attachment can be avoided. Therefore, the process yield and the product quality will be improved.

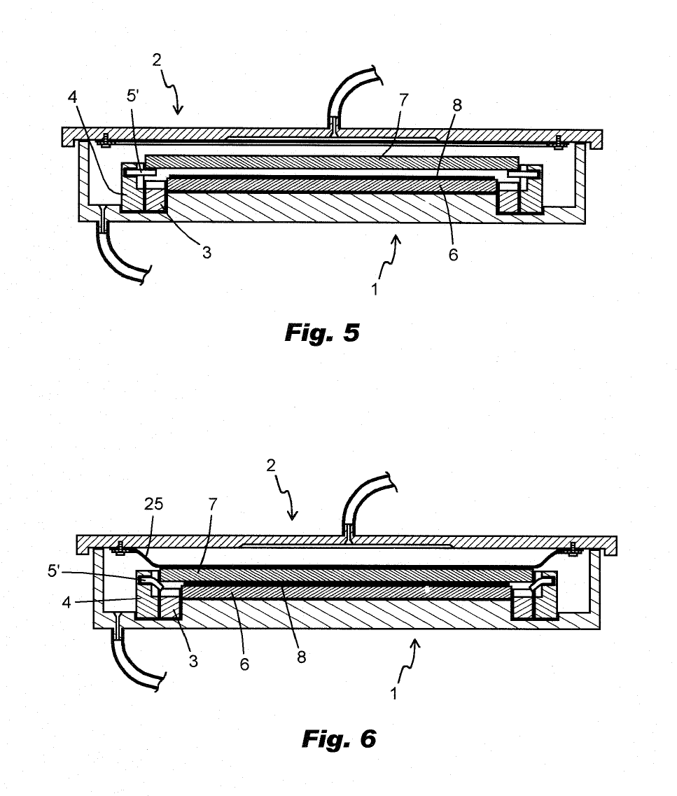

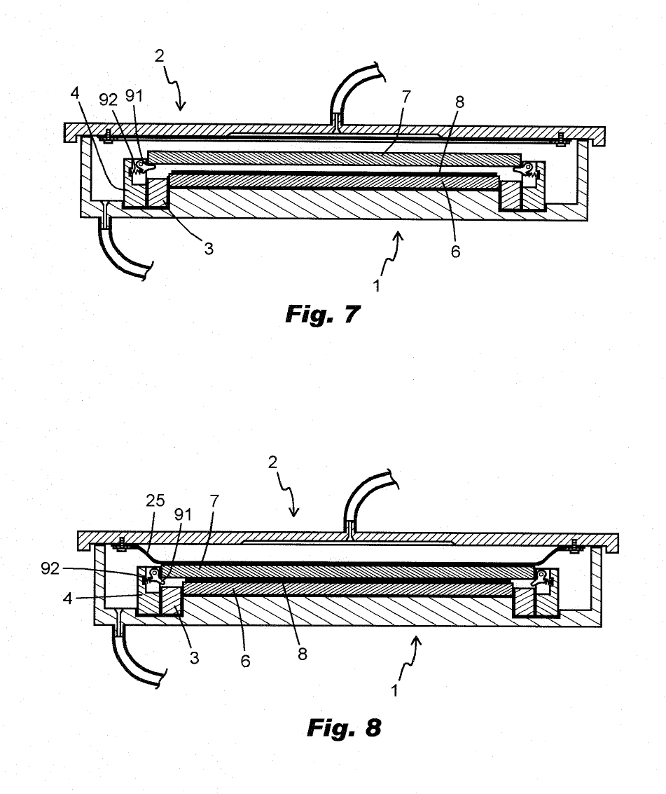

The present invention is thus described, it will be obvious that the same may be varied in many ways. For example, a spring can be a substitute for the elastic bolt 5. The elastic bolts 5 can be perpendicularly fixed to an inner wall of the upper plate positioning frame 4 so as to be bent under pressure by the upper plate 7 as shown in FIGS. 5 and 6. Referring to FIGS. 7 and 8, a buckle unit having a buckle 91 and a spring 92 can be a equivalent of the elastic bolt 5. The buckle 91 is pivoted to the wall of the upper plate positioning frame 4 and the spring 92 is supported against the buckle 91. The buckle 91 can swing down under downward pressure so as to lower the upper plate 7 holding by the buckle 91 to the lower plate 6. Such variations are not to be regarded as a departure from the spirit and scope of the present invention, and all such modifications as would be obvious to one skilled in the art are intended to be included within the scope of the following claims.

What is claimed is:

1. An improved laminating equipment for touch panel comprising:
a working recess having a base plate on a bottom thereof for placing a first plate, a vent connected to a vacuum pump being formed to the working recess;
a first positioning frame arranged around the base plate to confine a positioning place for the first plate; a top of the first positioning frame is being lower than a top of the first plate placed thereon;
a second positioning frame arranged around the first positioning frame to confine a positioning place for a second plate; a top of the second positioning frame being lower than a top of the second plate placed thereon;
a plurality of elastic supporter arranged within the second positioning frame and outside the first positioning frame for supporting the second plate and forming a gap between the first and the second plates;
a pressing cap serving to open and close the working recess arranged above the working recess; a pressing unit having a soft contact surface being arranged to the pressing cap to press the second plate;
wherein the first and the second plates are precisely placed on the first and the second positioning frame respectively; the working recess is sealed by the covering of the pressing cap so as to create vacuum by the vacuum pump; the pressing unit will provide a downward force to the second plate to overcome the support of the plurality of elastic supporter so as to attach the first and the second plates as one.

2. The improved laminating equipment for touch panel as claimed in claim 1, wherein the plurality of elastic support is elastic bolt perpendicularly arranged to a top of the first positioning frame; the plurality of elastic bolt is made of one of a crude rubber, composite rubber, or elastic plastic.

3. The improved laminating equipment for touch panel as claimed in claim 1,
wherein the plurality of elastic support is elastic bolt perpendicularly arranged to an inner wall of the first positioning frame; the plurality of elastic bolt is made of one of a crude rubber, composite rubber, or elastic plastic.

4. The improved laminating equipment for touch panel as claimed in claim 1,
wherein the plurality of elastic supporter is spring.

5. The improved laminating equipment for touch panel as claimed in claim 1,
wherein the plurality of elastic support is a buckle unit arranged to an inner wall of the second positioning frame; the buckle unit has a buckle and a spring; an end of the buckle is pivoted to the inner wall of the second positioning frame and an opposite end thereof is supported by the spring.

6. The improved laminating equipment for touch panel as claimed in claim 1,
wherein the pressing unit is an elastic film; a periphery of the elastic film is sealed and fixed to a bottom surface of the pressing cap; a center of the elastic film is inflated or deflated by an air pump.

7. The improved laminating equipment for touch panel as claimed in claim 1,
wherein the pressing unit is an air bag being inflated or deflated by an air pump.

8. The improved laminating equipment for touch panel as claimed in claim 1,
wherein the second plate is a hard thin plate.

9. The improved laminating equipment for touch panel as claimed in claim 1
further comprising a gluing layer arranged to an upper surface of the first plate.

10. The improved laminating equipment for touch panel as claimed in claim
further comprising a gluing layer arranged to a bottom surface of the second plate.
